(19) United States
(12) Patent Application Publication
(10) Pub. No.: US 2025/0010519 A1
(43) Pub. Date: Jan. 9, 2025

(54) METHOD OF MANUFACTURING WAFER AND SEPARATING APPARATUS

(71) Applicant: DISCO CORPORATION, Tokyo (JP)

(72) Inventor: Kazuya HIRATA, Tokyo (JP)

(21) Appl. No.: 18/755,918

(22) Filed: Jun. 27, 2024

(30) Foreign Application Priority Data
Jul. 4, 2023 (JP) 2023-110071

(51) Int. Cl. B28D 5/04; B23K 26/00; B23K 26/53; B23K 101/40; B28D 5/00

(52) U.S. Cl. CPC B28D 5/047; B23K 26/0093; B23K 26/53; B28D 5/0082; B23K 2101/40

(57) ABSTRACT

After ultrasonic waves have been applied via a layer of liquid to an ingot for separating the ingot along separation layers formed therein to thereby produce a wafer from the ingot, the wafer and the ingot are moved relatively to each other along a direction in which the separation layers extend, thereby pulling apart the wafer and the ingot from each other.

### BACKGROUND OF THE INVENTION

### Field of the Invention

The present invention relates to a method of manufacturing a wafer from an ingot and a separating apparatus.

### Description of the Related Art

Semiconductor device chips are generally fabricated from a wafer made of a single crystal of silicon (Si), silicon carbide (SiC), gallium nitride (GaN), lithium tantalate (LiTaO₃:LT), or lithium niobate (LiNbO₃:LT). The wafer is fabricated from an ingot by separating the ingot with a laser beam having a wavelength transmittable through the material of the ingot (see, for example, JP 2016-111143A).

According to the process of fabricating the wafer from the ingot, the ingot and a focused spot of the laser beam that is positioned within the ingot are moved relatively to each other along a predetermined direction, and then the ingot and the position where the focused spot is formed are moved relatively to each other along a direction perpendicular to the predetermined direction. The relative movement of the ingot and the focused spot and the relative movement of the ingot and the position where the focused spot is formed are alternately repeated to form in the ingot a plurality of separation layers each including a modified area and cracks developed from the modified area.

According to the above process, external forces are imposed on the ingot to further develop the cracks. As a result, a thin piece is separated as the wafer from the ingot along the separation layers. One proposed method of applying external forces to an ingot that has separation layers formed therein starts by applying ultrasonic waves through a layer of liquid to the ingot, followed by separating a thin piece as a wafer from the ingot in a direction perpendicular to the interface between the wafer and the ingot (see, for example, JP 2019-102513A).

### SUMMARY OF THE INVENTION

When the ultrasonic waves are applied via the layer of liquid to the ingot with the separation layers formed therein, the liquid seeps into each of the separation layers. Therefore, when the wafer is separated from the ingot at the separation layers, a layer of liquid remains between the wafer and the ingot.

When the wafer and the ingot are pulled apart in a direction perpendicular to the interface between the wafer and the ingot, strong resistive forces caused by the surface tension of the layer of liquid act on the wafer and the ingot. Consequently, the strong forces acting on the wafer and the ingot upon separation of the wafer and the ingot from each other tend to break at least one of the wafer or the ingot.

In view of the foregoing problems, it is an object of the present invention to provide a method of manufacturing a wafer from an ingot and a separating apparatus that make at least one of the wafer or the ingot less probable to be broken when ultrasonic waves are applied through a layer of liquid to the ingot and then the wafer is separated from the ingot along a plurality of separation layers formed in the ingot.

In accordance with an aspect of the present invention, there is provided a method of manufacturing a wafer from an ingot, including a separation layer forming step of alternately repeating relative movement along a predetermined direction of the ingot and a focused spot of a laser beam having a wavelength transmittable through a material of the ingot while the focused spot is being positioned within the ingot and relative movement of the ingot and a position where the focused spot is formed along a direction perpendicular to the predetermined direction, thereby forming, in the ingot, a plurality of separation layers each including a modified area and cracks developed from the modified area, after the separation layer forming step, an ultrasonic wave applying step of applying ultrasonic waves via a layer of liquid to the ingot to separate the ingot along the separation layers, thereby producing the wafer from the ingot, and after the ultrasonic wave applying step, a pulling-apart step of pulling apart the wafer and the ingot from each other by moving the wafer and the ingot relatively to each other along the predetermined direction.

In accordance with another aspect of the present invention, there is provided a method of manufacturing a wafer from an ingot having formed therein a plurality of separation layers each extending in a predetermined direction and including a modified area and cracks developed from the modified area, including an ultrasonic wave applying step of applying ultrasonic waves via a layer of liquid to the ingot to separate the ingot along the separation layers, thereby producing the wafer from the ingot, and after the ultrasonic wave applying step, a pulling-apart step of pulling apart the wafer and the ingot from each other by moving the wafer and the ingot relatively to each other along the predetermined direction.

In each of the above methods, preferably, the separation layers are formed such that the modified areas included therein are positioned on a common hypothetical plane, and the cracks are so developed as to be inclined to the hypothetical plane.

In accordance with a further aspect of the present invention, there is provided a separating apparatus for manufacturing a wafer from an ingot having formed therein a plurality of separation layers each extending in a predetermined direction and including a modified area and cracks developed from the modified area, including a first holding unit for holding the ingot thereon, a second holding unit for holding the wafer thereon, an ultrasonic wave applying unit for applying ultrasonic waves via a layer of liquid to the ingot held on the first holding unit, a moving mechanism for moving the first holding unit and the second holding unit relatively to each other along the predetermined direction, and a controller for controlling the first holding unit, the second holding unit, the ultrasonic wave applying unit, and the moving mechanism, in which the controller, while controlling the first holding unit to hold the ingot thereon, controls the ultrasonic wave applying unit to apply ultrasonic waves via the layer of liquid to the ingot for separating the ingot along the separation layers to thereby produce the wafer, and thereafter, while controlling the first holding unit to hold the ingot thereon and controlling the second holding unit to hold the wafer thereon, controls the moving mechanism to move the first holding unit and the second holding unit relatively to each other along the predetermined direction for pulling apart the wafer and the ingot from each other.

Preferably, the separating apparatus further includes a specifying unit for specifying the predetermined direction.

According to the present invention, after ultrasonic waves have been applied via the layer of liquid to the ingot to separate the ingot at and along the separation layers, thereby fabricating the wafer from the ingot, the wafer and the ingot are moved relatively to each other in the predetermined direction, i.e., in the direction along which the separation layers extend, thereby pulling apart the wafer and the ingot from each other.

In such a case, resistive forces acting on the wafer and the ingot due to the surface tension of the layer of liquid are weaker than if the wafer and the ingot would otherwise be pulled apart in a direction perpendicular to the interface between the wafer and the ingot. Therefore, the present invention makes at least one of the wafer or the ingot less probable to be broken when they are pulled apart from each other.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1A is a perspective view schematically illustrating an ingot by way of example;

FIG. 1B is a side elevational view schematically illustrating the ingot illustrated in FIG. 1A;

FIG. 2 is a flowchart illustrating, by way of example, the sequence of a method of manufacturing a wafer from the ingot;

FIG. 3 is a perspective view schematically illustrating the manner in which a separation layer forming step of the method is carried out by a laser processing apparatus;

FIG. 4 is a flowchart illustrating the manner in which the laser processing apparatus operates to form a plurality of separation layers in the ingot;

FIG. 5 is an enlarged fragmentary cross-sectional view schematically illustrating the ingot obtained after the separation layer forming step;

FIG. 6 is a perspective view, partly in block form, schematically illustrating a separating apparatus that is capable of performing an ultrasonic wave applying step and a pulling-apart step of the method;

FIG. 7 is a side elevational view schematically illustrating the manner in which the ultrasonic wave applying step is carried out;

FIG. 8 is an enlarged fragmentary cross-sectional view schematically illustrating the ingot and the wafer fabricated from the ingot obtained after the ultrasonic wave applying step;

FIG. 9A is a side elevational view schematically illustrating the manner in which the pulling-apart step is carried out; and

FIG. 9B is a side elevational view schematically illustrating the manner in which the pulling-apart step is carried out.

### DETAILED DESCRIPTION OF THE PREFERRED EMBODIMENT

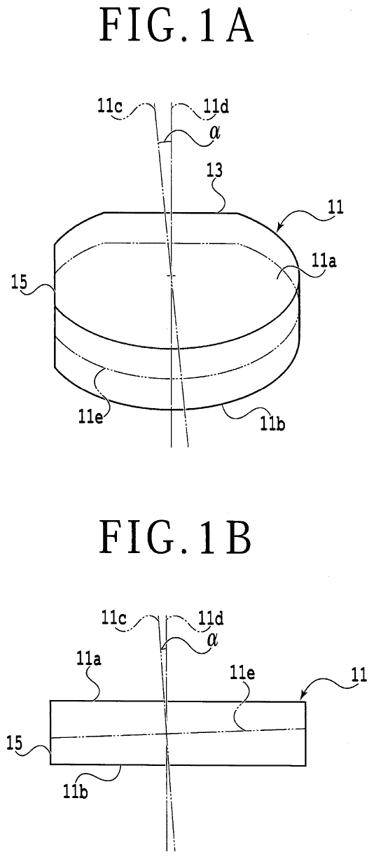

A preferred embodiment of the present invention will be described below with reference to the accompanying drawings. FIG. 1A schematically illustrates in perspective an ingot by way of example, and FIG. 1B schematically illustrates in side elevation the ingot illustrated in FIG. 1A. The ingot denoted by 11 in FIGS. 1A and 1B is made of a single crystal of SiC, for example, and is of a cylindrical shape having a face side 11a on an axial end thereof and a reverse side 11b on an opposite axis end thereof.

The ingot 11 is manufactured by epitaxial growth. The ingot 11 is manufactured such that a c-axis 11c of SiC is slightly inclined to a line 11d normal to the face side 11a and the reverse side 11b. For example, the c-axis 11c is inclined to the line 11d by an angle, i.e., an off-angle, α ranging from 1° to 6°, typically 4°.

The ingot 11 has, on an outer circumferential side surface thereof, two flat facets representing crystal orientations of SiC, i.e., a primary orientation flat 13 and a secondary orientation flat 15. The primary orientation flat 13 is longer than the secondary orientation flat 15 along directions perpendicular to the line 11d. The secondary orientation flat 15 extends parallel to a crossing line where a plane parallel to a c-plane 11e of SiC crosses the face side 11a or the reverse side 11b.

The ingot 11 may be made of a single crystal of a material, e.g., Si, GaN, LT, or LN, other than SiC. The outer circumferential side surface of the ingot 11 may be free of one of or both the primary orientation flat 13 and the secondary orientation flat 15, or a notch representing crystal orientations of the material of the ingot 11 may be defined in the outer circumferential side surface of the ingot 11 instead of the primary orientation flat 13 and the secondary orientation flat 15.

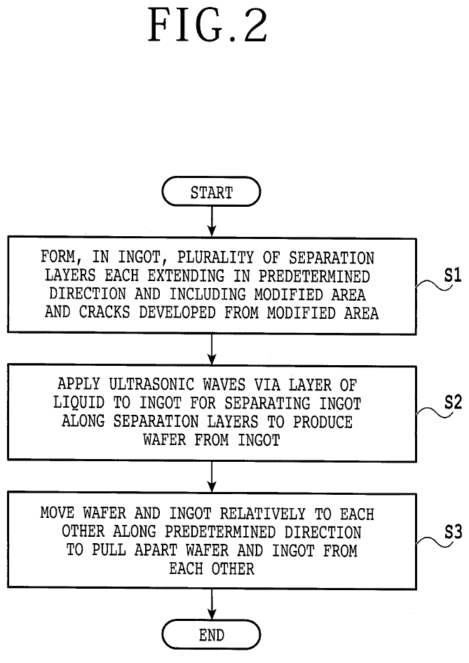

FIG. 2 is a flowchart illustrating by way of example the sequence of a method of manufacturing a wafer from the ingot 11. According to the method, a plurality of separation layers each including a modified area and cracks developed from the modified area are formed in the ingot 11 along a predetermined direction (separation layer forming step S1). The predetermined direction extends parallel to the crossing line referred to above, i.e., parallel to the secondary orientation flat 15, for example.

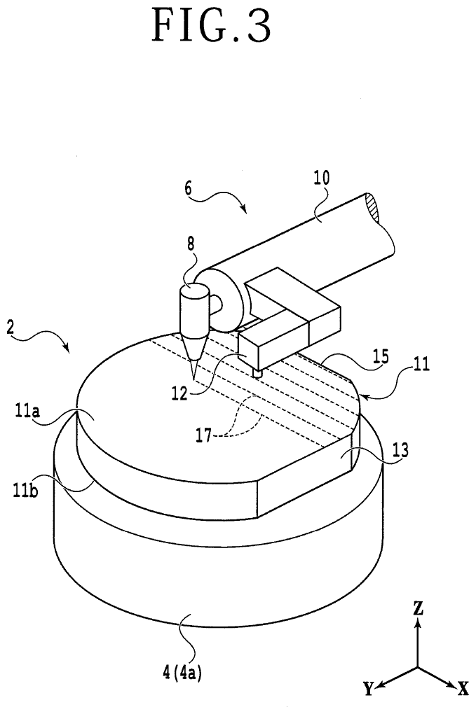

FIG. 3 schematically illustrates, in perspective, the manner in which separation layer forming step S1 is carried out. In FIG. 3, an X-axis and a Y-axis represented respectively by an arrow X and an arrow Y extend along respective directions, i.e., horizontal directions, extending perpendicularly to each other on a horizontal plane, and a Z-axis represented by an arrow Z extends along a direction, i.e., a vertical direction, extending perpendicular to the X-axis and the Y-axis. Separation layer forming step S1 is carried out by a laser processing apparatus 2 illustrated in FIG. 3.

As illustrated in FIG. 3, the laser processing apparatus 2 includes a holding unit 4 for holding the ingot 11 thereon. The holding unit 4 includes a chuck table 4a having a circular holding surface that lies substantially horizontally, i.e., parallel to a horizontal plane along the X-axis and the Y-axis, and a suction mechanism, not depicted, held in fluid communication with the chuck table 4a.

The suction mechanism has an ejector, for example. When the suction mechanism is actuated, it generates a vacuum, i.e., a suction force, that is transmitted to a space near the holding surface of the chuck table 4a. When the suction mechanism is actuated with the ingot 11 placed on the holding surface of the chuck table 4a, the ingot 11 is held under suction on the holding surface.

The chuck table 4a is operatively coupled to a rotating mechanism, not depicted. The rotating mechanism has a pulley and an electric motor connected to the pulley, all not depicted. When the rotating mechanism is actuated, it turns the chuck table 4a about its vertical central axis along the Z-axis. The rotating mechanism turns the chuck table 4a until the secondary orientation flat 15 of the ingot 11 held on the holding surface of the chuck table 4a lies parallel to the X-axis, for example.

The laser processing apparatus 2 also includes a laser beam applying unit 6 having a head 8 disposed above the chuck table 4a. The head 8 is mounted on the distal end of a hollow cylindrical housing 10 that extends along the Y-axis. The head 8 houses therein an optical system, not depicted, including a condensing lens, e.g., a condensing lens having a numerical aperture (NA) of 0.65, and a mirror. The housing 10 houses therein an optical system, not depicted, including a mirror and/or a lens, therein.

The housing 10 has a proximal end, not depicted, connected to a moving mechanism, not depicted. The moving mechanism has a ball screw and a motor, all not depicted, for example. When the moving mechanism is actuated, it moves the head 8 and the housing 10 along the X-axis, the Y-axis, and/or the Z-axis. The laser beam applying unit 6 has a laser oscillator, not depicted, including a laser medium such as Nd:YAG, for example.

The laser oscillator generates and emits a pulsed laser beam having a wavelength of 1064 nm, for example, transmittable through the material of the ingot 11, a frequency of 60 kHz, for example, and a pulse duration of 4 ns, for example. The laser beam emitted from the laser oscillator has its average output power adjusted to 1.5 W, for example, by an attenuator, not depicted, then travels through the optical systems housed in the housing 10 and the head 8, and is emitted downwardly from the head 8.

An image capturing unit 12 for capturing an image of an area immediately therebelow is mounted on a side of the housing 10 adjacent to the head 8. The image capturing unit 12 has a light source such as a light emitting diode (LED), an objective lens, and an image capturing device such as a charge coupled device (CCD) image sensor or a complementary metal oxide semiconductor (CMOS) image sensor, for example.

In preparation for separation layer forming step S1 on the laser processing apparatus 2, the ingot 11 with the face side 11a facing upwardly is placed on the holding surface of the chuck table 4a. Then, the suction mechanism is actuated to hold the ingot 11 under suction on the holding surface. Thereafter, the rotating mechanism is actuated to turn the chuck table 4a about its vertical central axis until a predetermined direction of the ingot 11, i.e., a direction parallel to the secondary orientation flat 15, lies parallel to the X-axis on the basis of an image captured of the face side 11a of the ingot 11 by the image capturing unit 12.

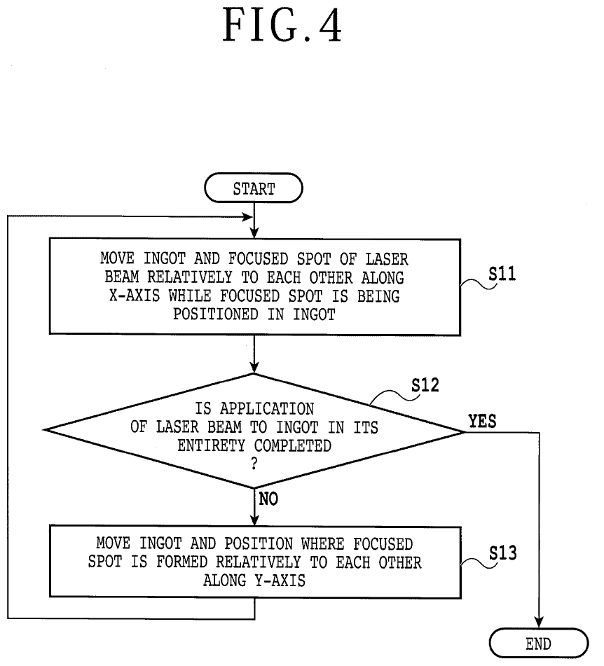

Then, in separation layer forming step S1, a plurality of separation layers are formed in the ingot 11. FIG. 4 is a flowchart illustrating the manner in which the laser processing apparatus 2 operates to form a plurality of separation layers in the ingot 11 in separation layer forming step S1. Specifically, the moving mechanism is actuated to move the head 8 and the housing 10 along the X-axis and/or the Y-axis to orient a region of the ingot 11 that is situated slightly inwardly from the secondary orientation flat 15 along the X-axis as viewed from the head 8 in plan.

Then, the moving mechanism is actuated to move the head 8 and the housing 10 along the Z-axis to position a focused spot of the laser beam emitted from the head 8, e.g., a focused spot having a diameter of 3.0 μm, at a predetermined depth from the face side 11a of the ingot 11, e.g., a depth of 300 μm from the face side 11a of the ingot 11. Thereafter, while the laser beam is being emitted from the head 8, the moving mechanism is actuated to move the head 8 and the housing 10 along the X-axis at a predetermined speed, e.g., a speed of 200 mm/s, thereby causing the focused spot to travel all the way from one end to the other of the ingot 11 along the X-axis.

In other words, while the focused spot is being positioned within the ingot 11, the ingot 11 and the focused spot are moved relatively to each other along the X-axis (laser beam applying step S11). In such a manner, the region of the ingot 11 referred to above is irradiated with the laser beam to form a modified area 17 where the crystal structure of the material, i.e., SiC in the present embodiment, is disturbed around the focused spot in the ingot 11 as the focused spot travels with respect to the ingot 11 along the X-axis.

If the laser beam has not been applied to the ingot 11 in its entirety (step S12: NO), then the ingot 11 and the position where the focused spot is formed are moved relatively to each other along the Y-axis (indexing feed step S13). Specifically, the moving mechanism is actuated to move the head 8 and the housing 10 a predetermined indexed distance ranging from 250 to 400 μm, for example, along the Y-axis until the head 8 is oriented along the X-axis as viewed from a next region of the ingot 11 that is spaced slightly from the already irradiated region of the ingot 11 away from the secondary orientation flat 15 in plan.

Then, the laser beam is applied again to the ingot 11 while the ingot 11 and the focused spot of the laser beam are moved relatively to each other along the X-axis (laser beam applying step S11), forming a modified area 17 in the next region of the ingot 11 that is irradiated with the laser beam. Thereafter, indexing feed step S13 and laser beam applying step S11 are alternately repeated until the laser beam is applied to a final region of the ingot 11 that is farthest from the secondary orientation flat 15, thereby completing the application of the laser beam to the ingot 11 in its entirety and hence the formation of modified areas 17 entirely in the ingot 11. Separation layer forming step S1 is now finished.

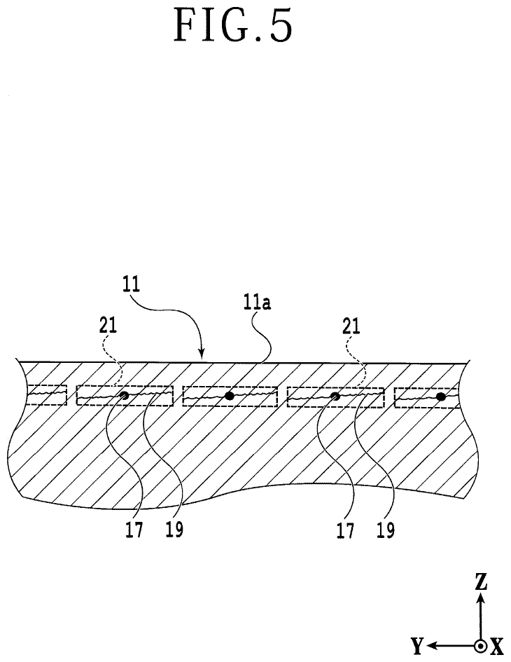

FIG. 5 schematically illustrates, in enlarged fragmentary cross section, the ingot 11 after separation layer forming step S1. In separation layer forming step S1, a plurality of modified areas 17 each extending in a predetermined direction, e.g., along the X-axis in the present embodiment, and having its center positioned at a predetermined depth from the face side 11a of the ingot 11, are formed in the ingot 11.

Stated otherwise, in separation layer forming step S1, the modified areas 17 are formed at equal spaced intervals in directions perpendicular to the predetermined direction, i.e., along the Y-axis, and positioned on a hypothetical plane generally parallel to the face side 11a of the ingot 11. When the modified areas 17 are formed in the ingot 11, the volume of the ingot 11 is expanded, exerting internal stresses in the ingot 11.

The internal stresses are relaxed by cracks 19 developed from the modified areas 17. The cracks 19 extend along the c-plane 11e that is inclined to the face side 11a of the ingot 11. Therefore, the cracks 19 extend obliquely to the hypothetical plane on which the modified areas 17 are positioned.

As a result, in separation layer forming step S1, a plurality of separation layers 21 are formed in the ingot 11, each extending in the predetermined direction and including one of the modified areas 17 and the cracks 19 developed therefrom.

After separation layer forming step S1, ultrasonic waves are applied via a layer of liquid to the ingot 11 in order to separate the ingot 11 at and along the separation layers 21 to fabricate a wafer from the ingot 11 (ultrasonic wave applying step S2), and then the wafer and the ingot 11 are moved relatively to each other along the predetermined direction, pulling the wafer and the ingot 11 apart from each other (pulling-apart step S3).

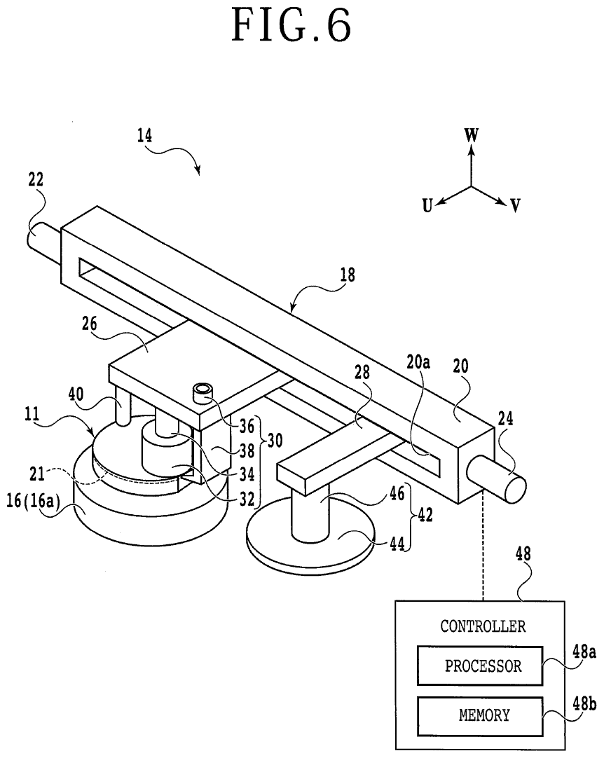

FIG. 6 schematically illustrates, in perspective, partly in block, a separating apparatus that is capable of performing ultrasonic wave applying step S2 and pulling-apart step S3. In FIG. 6, a U-axis and a V-axis represented respectively by an arrow U and an arrow V extend along respective directions, i.e., horizontal directions, extending perpendicularly to each other on a horizontal plane, and a W-axis represented by an arrow W extends along a direction, i.e., a vertical direction, extending perpendicular to the U-axis and the W-axis. In FIG. 6, some of the components of the separating apparatus are illustrated as blocks.

The separating apparatus, denoted by 14 in FIG. 6, includes a first holding unit 16 for holding the ingot 11 thereon. The first holding unit 16 includes a chuck table 16a having a circular holding surface that lies substantially horizontally, i.e., parallel to a horizontal plane along the X-axis and the Y-axis, and a suction mechanism, not depicted, held in fluid communication with the chuck table 16a.

The suction mechanism has an ejector, for example. When the suction mechanism is actuated, it generates a vacuum, i.e., a suction force, that is transmitted to a space near the holding surface of the chuck table 16a. When the suction mechanism is actuated with the ingot 11 placed on the holding surface of the chuck table 16a, the ingot 11 is held under suction on the holding surface.

The chuck table 16a is operatively coupled to a rotating mechanism, not depicted. The rotating mechanism has a pulley and an electric motor connected to the pulley, all not depicted. When the rotating mechanism is actuated, it turns the chuck table 16a about its vertical central axis along the W-axis. The rotating mechanism turns the chuck table 16a until the secondary orientation flat 15 of the ingot 11 held on the holding surface of the chuck table 16a lies parallel to the V-axis, for example.

The chuck table 16a is also operatively coupled to a W-axis moving mechanism, not depicted. The W-axis moving mechanism includes a ball screw and an electric motor connected to the ball screw. When the W-axis moving mechanism is actuated, it moves the chuck table 16a vertically along the W-axis, i.e., selectively lifts and lowers the chuck table 16a. For example, the W-axis moving mechanism lifts the chuck table 16a to bring the ingot 11 held on the holding surface of the chuck table 16a closely to an ultrasonic wave applying unit 30 or a second holding unit 42 to be described below.

The separating apparatus 14 further includes a V-axis moving mechanism 18 disposed obliquely above the chuck table 16a. The V-axis moving mechanism 18 has a frame 20 shaped as a horizontally elongate quadrangular prism extending along the V-axis and having a horizontally extending slot 20a defined therein and opening through a side surface of the frame 20 generally toward the chuck table 16a. A first ball screw, not depicted, and a second ball screw, not depicted, are rotatably housed in the frame 20 and extend longitudinally in the frame 20 along the V-axis.

The first ball screw has an externally threaded shaft whose proximal end portion extends through a through hole defined in an end, i.e., a rear end, of the frame 20 and is coupled to an electric motor 22. Similarly, the second ball screw has an externally threaded shaft whose proximal end portion extends through a through hole defined in another end, i.e., a front end, of the frame 20 and is coupled to an electric motor 24. A first movable plate 26 has a proximal end portion movably inserted in the slot 20a, and a second movable plate 28 has a proximal end portion movably inserted in the slot 20a.

The proximal end portion of the first movable plate 26 is fixed to a nut, not depicted, operatively threaded over the externally threaded shaft of the first ball screw. Similarly, the proximal end portion of the second movable plate 28 is fixed to a nut, not depicted, operatively threaded over the externally threaded shaft of the second ball screw. Therefore, when at least one of the electric motor 22 or the electric motor 24 is energized, at least one of the externally threaded shaft of the first ball screw or the externally threaded shaft of the second ball screw is rotated about its longitudinal axis, causing the corresponding nut to move at least one of the first movable plate 26 or the second movable plate 28 along the V-axis. The electric motors 22 and 24 are controlled to keep the first movable plate 26 and the second movable plate 28 out of contact with each other when at least one of them is moved along the V-axis.

The first movable plate 26 has a distal end portion extending away from the frame 20 and supporting thereon the ultrasonic wave applying unit 30 that applies ultrasonic waves via a layer of liquid to the ingot 11 held on the first holding unit 16 and an image capturing unit, i.e., a specifying unit, 40 that captures an image from which to specify the direction, i.e., the predetermined direction, in which each of the separation layers 21 formed in the ingot 11 extends.

The ultrasonic wave applying unit 30 has a cylindrical vibratory body 32 having a lower surface that can face the upper surface, e.g., the face side 11a, of the ingot 11 held on the first holding unit 16. The vibratory body 32 houses therein an ultrasonic vibrator, not depicted, that, when ultrasonically vibrated, ultrasonically vibrates the vibratory body 32 in its entirety.

The vibratory body 32 has an upper surface whose central region is fixed to a lower distal end of a joint 34 that is in turn fixed to a lower surface of the distal end portion of the first movable plate 26. The distal end portion of the first movable plate 26 has an upper surface including a corner on which there is mounted a tubular water supply port 36 that is supplied with liquid, e.g., water, from a liquid supply source, not depicted, through a pipe, not depicted, and a valve, not depicted.

The liquid that is supplied from the liquid supply source to the water supply port 36 is, along the V-axis, supplied through a passageway, not depicted, defined in the distal end portion of the first movable plate 26 to a liquid nozzle 38 extending downwardly from the distal end portion of the first movable plate 26 and positioned adjacent to the vibratory body 32 and the joint 34. The liquid supplied to the liquid nozzle 38 flows through a passageway, not depicted, defined in the liquid nozzle 38 and an opening, not depicted, defined in a lower surface thereof to a lower surface of the vibratory body 32.

The image capturing unit 40 has, for example, a light source such as an LED for emitting light having a wavelength transmittable through the ingot 11, an objective lens, and an image capturing device such as a CCD image sensor or a CMOS image sensor, for example. The image capturing unit 40 is capable of capturing an image of an area immediately therebelow.

The second movable plate 28 has a distal end portion extending away from the frame 20 and supporting thereon a second holding unit 42 for holding a wafer fabricated from the ingot 11 when it is separated from the ingot 11 along the separation layers 21. The second holding unit 42 has a suction pad 44 having a plurality of suction ports, not depicted, defined in a lower surface thereof.

The suction ports are held in fluid communication with a suction mechanism, not depicted, such as an ejector via a passageway, not depicted, defined in the suction pad 44, a pipe, not depicted, and a valve, not depicted, that are fluidly connected to the passageway. The suction pad 44 has an upper surface whose central region is fixed to a lower distal end of a joint 46 that is in turn fixed to a lower surface of the distal end portion of the second movable plate 28.

The separating apparatus 14 further includes a controller 48 for controlling the various components thereof, e.g., the first holding unit 16, the V-axis moving mechanism 18, the ultrasonic wave applying unit 30, the image capturing unit 40, and the second holding unit 42. The controller 48 has a processor 48a and a memory 48b.

The processor 48a includes a central processing unit (CPU). The memory 48b includes a volatile memory such as a dynamic random access memory (DRAM) or a static random access memory (SRAM) and a nonvolatile memory such as a solid state drive (SSD) also referred to as a NAND-type flash memory or a hard disk drive (HDD) also referred to as a magnetic storage device.

The memory 48b stores data and programs used by the processor 48a. The processor 48a controls the components of the separating apparatus 14 by reading and executing the programs stored in the memory 48b.

The separating apparatus 14 operates as follows. When the ingot 11 with the separation layers 21 formed therein is introduced into the separating apparatus 14, the ingot 11 with the face side 11a facing upwardly is placed on the holding surface of the chuck table 16a. Then, the controller 48 controls the first holding unit 16, or specifically, the suction mechanism fluidly connected to the chuck table 16a, to hold the ingot 11 under suction on the holding surface of the chuck table 16a.

Thereafter, the controller 48 controls the V-axis moving mechanism 18, or specifically, the electric motor 22, to position the vibratory body 32 immediately above the ingot 11 on the chuck table 16a. Then, the controller 48 controls the W-axis moving mechanism operatively coupled to the chuck table 16a, to lift the chuck table 16a until the lower surface of the vibratory body 32 is brought closely to the face side 11a of the ingot 11.

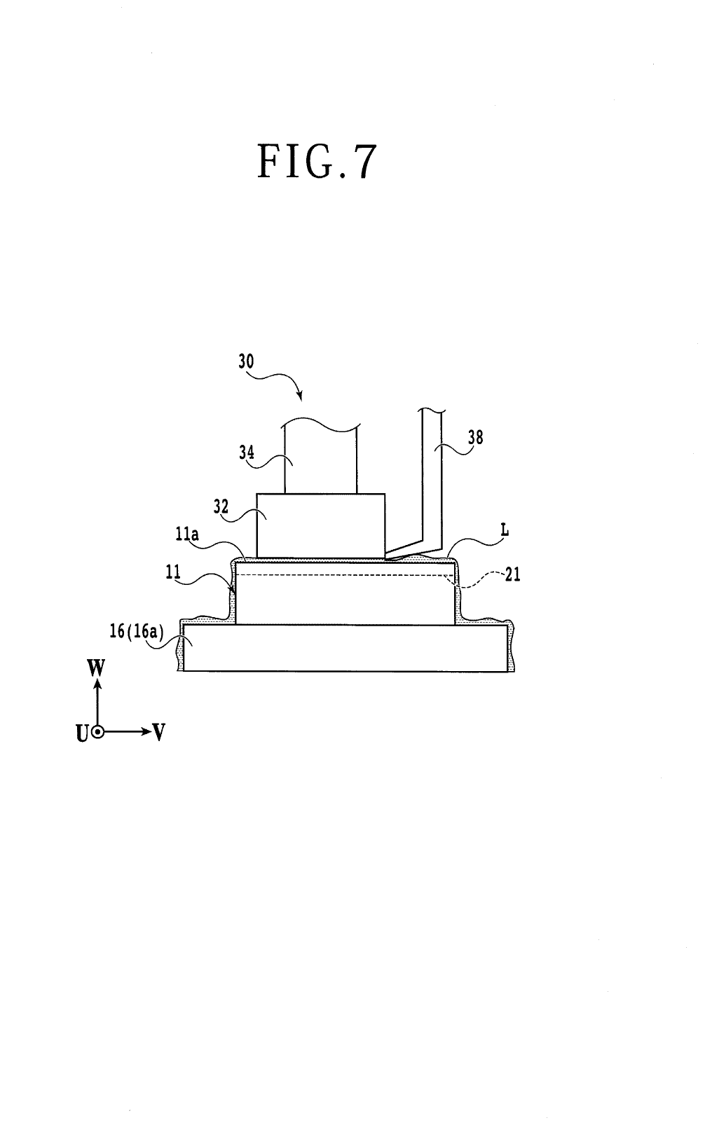

Then, the controller 48 controls the ultrasonic wave applying unit 30 to apply ultrasonic waves via a layer of liquid to the ingot 11 for fabricating a wafer from the ingot 11 by separating the wafer from the ingot 11 along the separation layers 21. In other words, the separating apparatus 14 carries out ultrasonic wave applying step S2 of the method illustrated in FIG. 2. FIG. 7 schematically illustrates, in side elevation, the manner in which ultrasonic wave applying step S2 is carried out.

In ultrasonic wave applying step S2, the controller 48 controls the ultrasonic vibrator housed in the vibratory body 32, to ultrasonically vibrate the vibratory body 32 in its entirety, and at the same time controls the liquid supply source to supply liquid L from the liquid nozzle 38 to the lower surface of the vibratory body 32.

At this time, while the vibratory body 32 is being vibrated and the liquid L is being supplied to the lower surface of the vibratory body 32, the controller 48 may control the rotating mechanism operatively coupled to the chuck table 16a, to rotate the chuck table 16a about its vertical central axis. In such a manner, ultrasonic waves are applied to the ingot 11 through a layer of liquid L as a medium, thereby ultrasonically vibrating the ingot 11. When the ingot 11 has been ultrasonically vibrated until the wafer is separated therefrom, ultrasonic wave applying step S2 is completed.

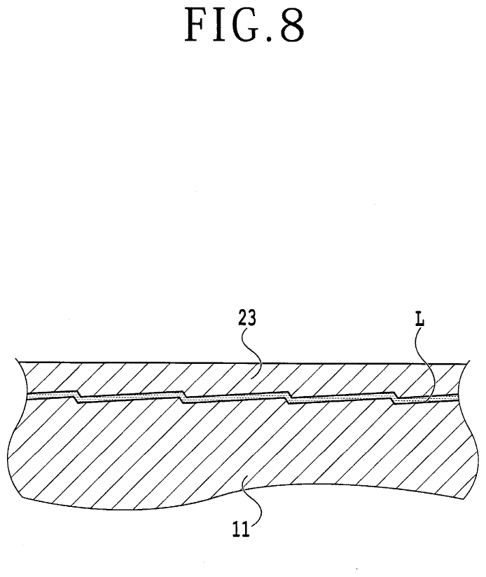

FIG. 8 schematically illustrates, in enlarged fragmentary cross section, the ingot 11 and the wafer fabricated from the ingot 11 after ultrasonic wave applying step S2. In ultrasonic wave applying step S2, the cracks 19 included in each of the separation layers 21 are developed to the extent that more cracks are exposed on the outer circumferential side surface of the ingot 11 and the cracks 19 included in each of adjacent pairs of the separation layers are joined to each other.

At this time, the liquid L seeps into the ingot 11 through the cracks 19 that are exposed on the outer circumferential side surface of the ingot 11. The ingot 11 is separated at and along the separation layer 21, producing a wafer 23 as a separated piece having the face side 11a. Therefore, a layer of liquid L remains in the interface between the ingot 11 and the wafer 23.

The cracks 19 included in each of the separation layers 21 are developed along the c-plane 11e that is inclined to the face side 11a of the ingot 11. Consequently, the ingot 11 and the wafer 23 have newly exposed surfaces, respectively, having an undulating shape in a direction perpendicular to the direction, i.e., the predetermined direction, along which the separation layers 21 extend in the ingot 11. Stated otherwise, the exposed surfaces of the ingot 11 and the wafer 23 have a maximum height Wz that is smaller in the predetermined direction but larger in the direction perpendicular to the predetermined direction.

Then, the controller 48 controls the ultrasonic wave applying unit 30 to stop applying the ultrasonic waves through the layer of liquid L to the ingot 11. Specifically, the controller 48 controls the ultrasonic vibrator, the liquid supply source, and the W-axis moving mechanism operatively coupled to the chuck table 16a, to stop vibrating the vibratory body 32, stop supplying the liquid L to the lower surface of the vibratory body 32, and lower the chuck table 16a.

Then, the controller 48 controls the V-axis moving mechanism 18, or specifically, the electric motor 22, to position the image capturing unit 40 immediately above the ingot 11. Then, the controller 48 controls the image capturing unit 40 to capture an image from which to specify the predetermined direction. For example, the controller 48 controls the image capturing unit 40 to capture an image that is focused on the interface between the ingot 11 and the wafer 23.

Since the undulations of the newly exposed surfaces of the ingot 11 and the wafer 23 can be recognized by referring to the captured image, it is possible to specify the predetermined direction. Then, the controller 48 controls the rotating mechanism operatively coupled to the chuck table 16a, to turn the chuck table 16a about its vertical central axis and orient the predetermined direction specified from the image parallel to the V-axis.

Then, the controller 48 controls the V-axis moving mechanism 18, or specifically, the electric motors 22 and 24, to move the image capturing unit 40 away from the ingot 11 as viewed in plan and to position the suction pad 44 immediately above the ingot 11. Then, the controller 48 controls the W-axis moving mechanism operatively coupled to the chuck table 16a, to lift the chuck table 16a until the lower surface of the suction pad 44 contacts the wafer 23.

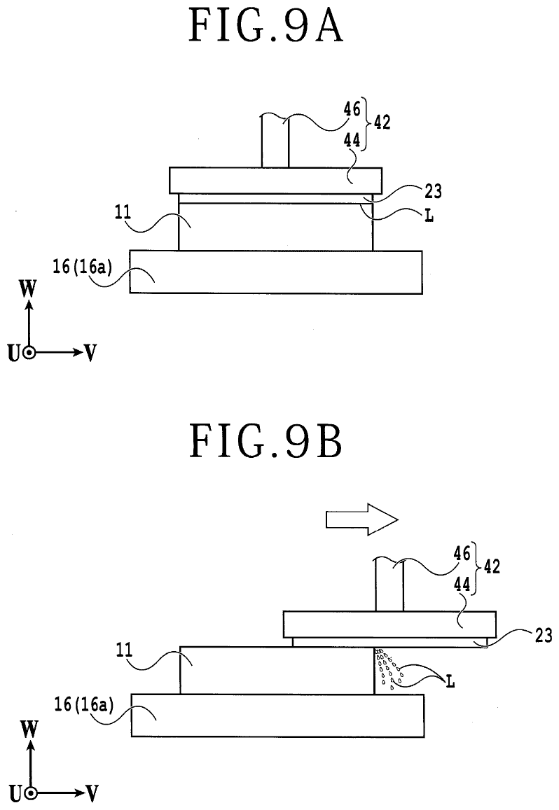

Then, the controller 48 controls the second holding unit 42 and the V-axis moving mechanism 18, or specifically, the electric motor 24, to move the wafer 23 and the ingot 11 relatively to each other in the predetermined direction along the V-axis. In other words, the separating apparatus 14 carries out pulling-apart step S3. Each of FIGS. 9A and 9B schematically illustrates, in side elevation, the manner in which pulling-apart step S3 is carried out.

In pulling-apart step S3, the controller 48 first controls the second holding unit 42, or specifically, the suction mechanism fluidly connected to the suction ports defined in the lower surface of the suction pad 44, to hold the wafer 23 under suction on the second holding unit 42 (see FIG. 9A). Then, while the wafer 23 is being held under suction on the second holding unit 42, the controller 48 controls the V-axis moving mechanism 18, or specifically, the electric motor 24, to pull the wafer 23 and the ingot 11 apart from each other along the V-axis (see FIG. 9B).

According to the method of manufacturing a wafer illustrated in FIG. 2, after ultrasonic waves have been applied via the layer of liquid L to the ingot 11 to separate the ingot 11 at and along the separation layers 21, thereby fabricating the wafer 23 from the ingot 11, the wafer 23 and the ingot 11 are moved relatively to each other in the predetermined direction, i.e., in the direction along which the separation layers 21 extend, thereby pulling apart the wafer 23 and the ingot 11 from each other.

In such a case, resistive forces acting on the wafer 23 and the ingot 11 due to the surface tension of the layer of liquid L are weaker than if the wafer 23 and the ingot 11 would otherwise be pulled apart in a direction perpendicular to the interface between the wafer 23 and the ingot 11. Therefore, the method of manufacturing a wafer according to the present embodiment makes at least one of the wafer 23 or the ingot 11 less probable to be broken when they are pulled apart from each other.

The details of the method of manufacturing a wafer described above are illustrative only, and the present invention is by no means limited to the above details. For example, the present invention may cover a method of manufacturing a wafer that lacks separation layer forming step S1 included in the method of manufacturing a wafer illustrated in FIG. 2. Specifically, the present invention may cover a method of manufacturing a wafer from an ingot in which a plurality of separation layers have already been formed.

The separating apparatus according to the present invention may have a V-axis moving mechanism for moving the first holding unit 16 along the V-axis in place of or in addition to the V-axis moving mechanism 18 for moving the ultrasonic wave applying unit 30 and the second holding unit 42 along the V-axis. Stated otherwise, the separating apparatus according to the present invention is not limited to any structural details that make the wafer 23 and the ingot 11 movable relatively to each other along the predetermined direction.

The separating apparatus according to the present invention may be free of the image capturing unit 40. In the absence of the image capturing unit 40, the predetermined direction may be specified by visually confirming the secondary orientation flat 15, for example, rather than by referring to an image captured by the image capturing unit 40.

The structural and methodological details of the embodiment described above may be changed or modified appropriately without departing from the scope of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A method of manufacturing a wafer from an ingot, comprising:
a separation layer forming step of alternately repeating relative movement along a predetermined direction of the ingot and a focused spot of a laser beam having a wavelength transmittable through a material of the ingot while the focused spot is being positioned within the ingot and relative movement of the ingot and a position where the focused spot is formed along a direction perpendicular to the predetermined direction, thereby forming, in the ingot, a plurality of separation layers each including a modified area and cracks developed from the modified area;
after the separation layer forming step, an ultrasonic wave applying step of applying ultrasonic waves via a layer of liquid to the ingot to separate the ingot along the separation layers, thereby producing the wafer from the ingot; and
after the ultrasonic wave applying step, a pulling-apart step of pulling apart the wafer and the ingot from each other by moving the wafer and the ingot relatively to each other along the predetermined direction.

2. The method of manufacturing a wafer according to claim 1, wherein the separation layers are formed such that the modified areas included therein are positioned on a common hypothetical plane; and
the cracks are so developed as to be inclined to the hypothetical plane.

3. A method of manufacturing a wafer from an ingot having formed therein a plurality of separation layers each extending in a predetermined direction and including a modified area and cracks developed from the modified area, comprising:
an ultrasonic wave applying step of applying ultrasonic waves via a layer of liquid to the ingot to separate the ingot along the separation layers, thereby producing the wafer from the ingot; and
after the ultrasonic wave applying step, a pulling-apart step of pulling apart the wafer and the ingot from each other by moving the wafer and the ingot relatively to each other along the predetermined direction.

4. The method of manufacturing a wafer according to claim 3, wherein
the separation layers are formed such that the modified areas included therein are positioned on a common hypothetical plane; and
the cracks are so developed as to be inclined to the hypothetical plane.

5. A separating apparatus for manufacturing a wafer from an ingot having formed therein a plurality of separation layers each extending in a predetermined direction and including a modified area and cracks developed from the modified area, comprising:
a first holding unit for holding the ingot thereon;
a second holding unit for holding the wafer thereon;
an ultrasonic wave applying unit for applying ultrasonic waves via a layer of liquid to the ingot held on the first holding unit;
a moving mechanism for moving the first holding unit and the second holding unit relatively to each other along the predetermined direction; and
a controller for controlling the first holding unit, the second holding unit, the ultrasonic wave applying unit, and the moving mechanism, wherein
the controller, while controlling the first holding unit to hold the ingot thereon, controls the ultrasonic wave applying unit to apply ultrasonic waves via the layer of liquid to the ingot for separating the ingot along the separation layers to thereby produce the wafer, and thereafter, while controlling the first holding unit to hold the ingot thereon and controlling the second holding unit to hold the wafer thereon, controls the moving mechanism to move the first holding unit and the second holding unit relatively to each other along the predetermined direction for pulling apart the wafer and the ingot from each other.

6. The separating apparatus according to claim 5, further comprising:
a specifying unit for specifying the predetermined direction.
